(19) United States
(12) Patent Application Publication
(10) Pub. No.: US 2021/0394096 A1
(43) Pub. Date: Dec. 23, 2021

(54) Multilayer Media Bed Filter Comprising Glass Bead Micromedia

(71) Applicant: Neptune-Benson LLC, Coventry, RI (US)

(72) Inventor: Alain Silverwood, Saint-Eustache (CA)

(73) Assignee: Neptune-Benson LLC, Coventry, RI (US)

(21) Appl. No.: 17/288,910

(22) PCT Filed: Oct. 24, 2019
(86) PCT No.: PCT/US2019/057748

§ 371 Date: Apr. 26, 2021

Related U.S. Application Data
(60) Provisional application No. 62/749,701, filed on Oct. 24, 2018.

(51) Int. Cl. B01D 39/06; B01D 24/12; B01D 24/46; C02F 1/00

(52) U.S. Cl. CPC B01D 39/06; B01D 24/12; C02F 2303/16; C02F 1/004; B01D 24/4631

(57) ABSTRACT

A filter is disclosed. The filter includes a vessel having at least one inlet and at least one outlet, a media bed including a plurality of media layers, an uppermost media layer of the media bed including substantially uniform and spherical glass micromedia, the plurality of media layers increasing in density from the uppermost media layer to a lowermost media layer and an air distributor configured to direct a volume of air through the plurality of media layers. A system for treating water is also disclosed. The system includes a source of water to be treated, a filter vessel as described herein, and a treated water outlet fluidically connected to a filter vessel outlet. A method of retrofitting a filter vessel as described herein is also disclosed. The method includes removing the uppermost media layer from the media bed and installing a media comprising substantially uniform and spherical glass bead micromedia into the media bed as the uppermost media layer. A method of facilitating water treatment is also disclosed. The method includes providing a filter vessel as described herein and instructing a user to connect an inlet of the filter vessel to a source of water to be treated.

### CROSS-REFERENCE TO RELATED APPLICATIONS

This application claims priority under 35 U.S.C. § 119(e) to U.S. Provisional Application No. 62/749,701 titled “Multilayer Media Bed Filter Comprising Glass Bead Media” filed Oct. 24, 2018, the disclosure of which is incorporated herein by reference in its entirety for all purposes.

### FIELD OF TECHNOLOGY

Aspects and embodiments disclosed herein are generally related to the field of multi-layer media bed filters and, in particular, to high capacity micromedia multi-layer media bed filters.

### SUMMARY

In accordance with an aspect, there is provided a filter. The filter may comprise a vessel having at least one inlet and at least one outlet, a media bed comprising a plurality of media layers, an uppermost media layer of the media bed comprising substantially uniform and spherical glass micromedia, the plurality of media layers increasing in density from the uppermost media layer to a lowermost media layer, and an air distributor configured to direct a volume of air through the plurality of media layers.

In some embodiments, the glass micromedia includes glass beads.

The glass beads may have a diameter from about 0.1 mm to 0.4 mm, such as a diameter from about 0.1 mm to 0.2 mm.

In some embodiments, the glass beads include a smooth exterior surface.

The density of the glass beads may be about 2.5 g/mL.

In accordance with another aspect, there is provided a method of retrofitting a media filter. The media filter may comprise a filter vessel fluidly connectable to a source of water, the filter vessel comprising a media bed comprising a plurality of media layers, the plurality of media layers increasing in density from an uppermost media layer to a lowermost media layer. The method may comprise removing the uppermost media layer from the media bed and installing a media comprising substantially uniform and spherical glass bead micromedia into the media bed as the uppermost media layer.

The glass beads may have a diameter from about 0.1 mm to 0.4 mm, such as diameter from about 0.1 mm to 0.2 mm.

The density of the glass beads may be about 2.5 g/mL.

In accordance with another aspect, there is provided a method of facilitating water treatment. The method may comprise providing a filter vessel comprising at least one inlet, at least one outlet, an air distributor, and a media bed, the media bed comprising a plurality of media layers, the plurality of media layers increasing in density from an uppermost media layer to a lowermost media layer, where the uppermost media layer comprises substantially uniform and spherical glass bead micromedia, and instructing a user to connect an inlet of the filter vessel to a source of water to be treated.

In some embodiments, the method may further comprise instructing the user to connect a source of air to the air distributor.

In some embodiments, the method may further comprise instructing the user to direct a volume of air through the air distributor and the plurality of media layers for a predetermined period of time.

In accordance with another aspect, there is provided a system for treating water. The system may comprise a source of water to be treated, a filter vessel having at least one inlet fluidically connected to the source of water to be treated, at least one outlet, and a media bed positioned within the filter vessel, the media bed comprising a plurality of media layers, an uppermost layer of the media bed comprising substantially uniform and spherical glass bead micromedia, the plurality of media layers increasing in density from the uppermost media layer to a lowermost media layer, and a treated water outlet fluidically connected to a filter vessel outlet.

The glass beads may have a diameter from about 0.1 mm to 0.4 mm, such as a diameter from about 0.1 mm to 0.2 mm.

The density of the glass beads may be about 2.5 g/mL.

In some embodiments, the source of water to be treated comprises inorganic or organic contaminants.

The filter vessel of the system may further comprise an air backwash system, comprising an air distributor positioned within the filter vessel having an inlet connectable to a source of air.

In some embodiments, a volume of air is delivered from the air distributor at a predetermined period of time during a filtration cycle and/or when the performance of the filter vessel decreases.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIGS. 1A-1B are box diagrams of filtration through and backwashing a filter including a multi-layered media bed. FIG. 1A is a box diagram of filtration and FIG. 1B is a box diagram of backwashing.

FIGS. 2A-2F are drawings of a horizontal embodiment of the filters of the present invention. FIGS. 2A and 2B are side views. FIG. 2C is a top-down view. FIGS. 2D and 2E are end-on views. FIG. 2F is a perspective view.

FIGS. 3A-3E are drawings of a vertical embodiment of the filters of the present invention. FIG. 3A is a side view. FIG. 3B is a top-down view. FIGS. 3C and 3D are front and back views, respectively. FIG. 3E is a perspective view.

FIG. 4 is an embodiment of a filter vessel that includes a media bed with a plurality of layers that increase in density and media particle diameter from the uppermost layer to the lowermost layer.

FIGS. 5A-5B are images of silica microsand and glass bead micromedia showing residual iron fouling remaining after backwash under the same operating conditions. FIG. 5A shown iron fouling on silica microsand media and FIG. 5B shown iron fouling on glass bead micromedia.

### DETAILED DESCRIPTION

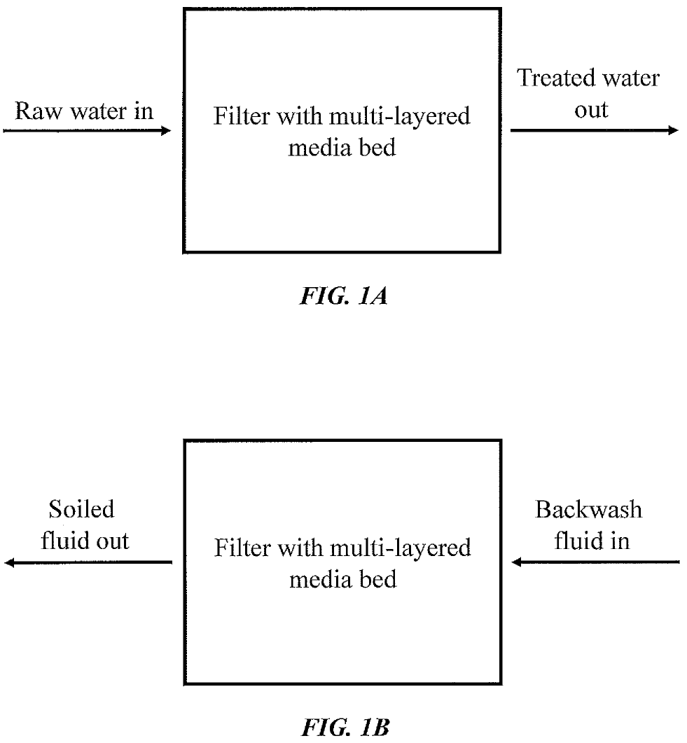

Embodiments disclosed herein provide for filters including media beds including a plurality of media layers, systems using said filters, and processes of their use. Applicant has discovered that a multi-layer media bed filter having a substantially uniform and spherical glass micromedia as the uppermost layer of the multi-layer media bed and an increasing density of media from the finest media on the top to the coarsest media on the bottom has improved filtration performance compared to traditional silica sand micromedia as the uppermost layer of the multi-layer media bed while retaining the advantages of silica sand micromedia for backwashing. The substantially uniform and spherical glass micromedia may be backwashed using air without significantly disrupting stratification of the media layers of the media bed and the outer surface finish of the substantially uniform and spherical glass micromedia offer improved cleaning during backwash as the smooth and glossy surface fouls less than traditional silica sand micromedia. A general scheme of the filtration and backwashing processes is shown in FIGS. 1A and 1B.

The use of air for this backwash removes contaminants from the substantially uniform and spherical glass micromedia into the liquid level above and around the substantially uniform and spherical glass micromedia. When the air is stopped, the contaminants in the liquid above the substantially uniform and spherical glass micromedia that were removed by the airflow are flushed away either with liquid injected above the media or by a liquid flow through the media bed that does not remove the substantially uniform and spherical glass micromedia. The amount of contaminants that are released from the substantially uniform and spherical glass micromedia with the stratification-maintaining air backwash is significantly greater than when using liquid backwash alone, whether the liquid backwash uses a flow rate sufficient to suspend the substantially uniform and spherical glass micromedia or below a suspending flow rate.

Applicant has further discovered that a media bed filter having a liquid flow through nozzles that create flow along a top surface of the media bed, without adverse displacement of the media, can be used during a backwash cleaning cycle to remove contaminants from the surface of the media bed with good efficiency. Typical filters would be unable to dislodge contaminants from the surface of the substantially uniform and spherical glass micromedia using the raw liquid inlet nozzles without risking sending the substantially uniform and spherical glass micromedia into the flow and losing a portion of the substantially uniform and spherical glass micromedia to the backwash. Such a use of the raw inlet nozzles is useful at a beginning of a backwash cycle. Alternatively, or in addition, such a use of the raw inlet nozzles is useful following an air backwash that has brought contaminants into a liquid level above the media bed.

A filter of the present invention includes a vessel having at least one inlet and at least one outlet, a media bed including a plurality of media layers, and an air distributor configured to direct a volume of air through the plurality of media layers. The filter may be a pressure-fed or high-rate filter. During filtration, the water to be treated may be fed to the filter vessel, for example, by one or more pumps. Inside the filter vessel, the water may be distributed by a water distribution head before coming into contact with the media bed having the plurality of media layers in the vessel. In general, the media layers of the media bed act as a substrate to retain solid contaminants, such as particulate inorganic or organic species, contained in the water. The filtered water is discharged from the filter vessel for its intended purpose, such as membrane pre-filtration, HVAC cooling tower filtration, process water filtration, data center cooling loops, commercial aquatics, such as recreation pool facilities, or similar high-volume applications.

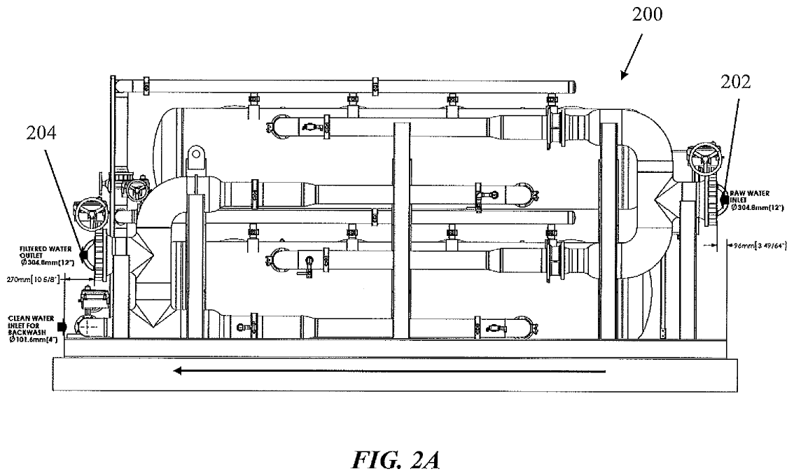

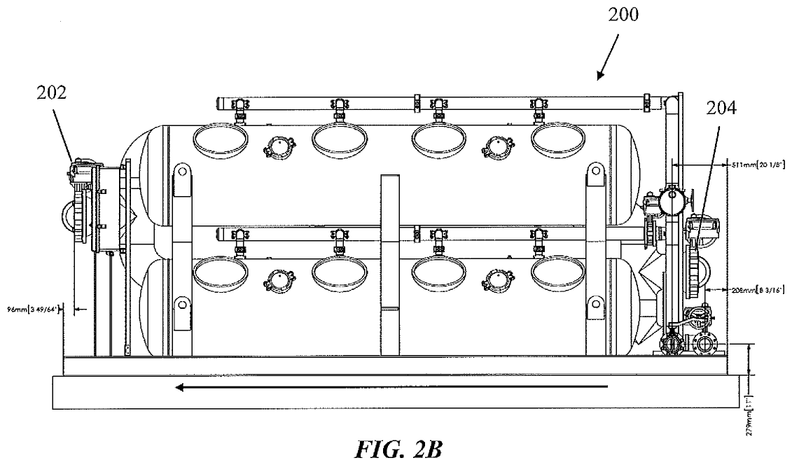

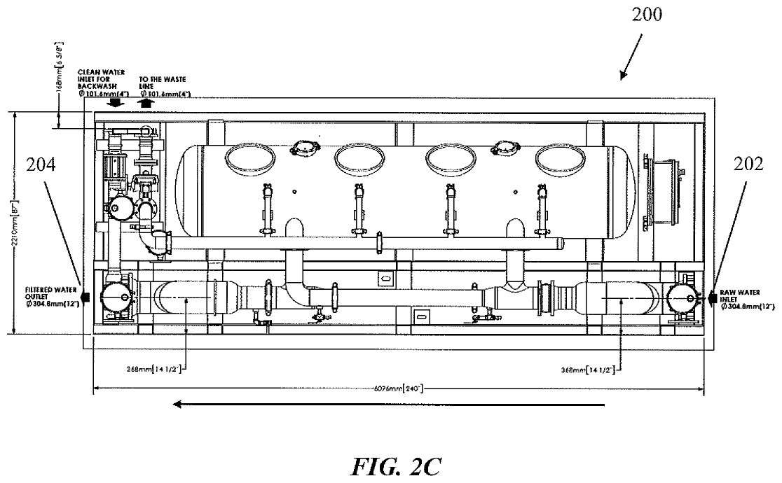

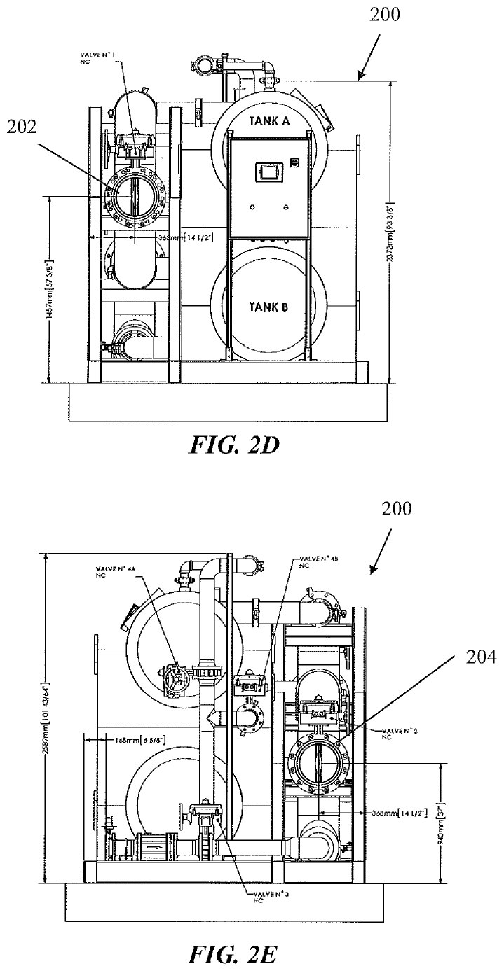

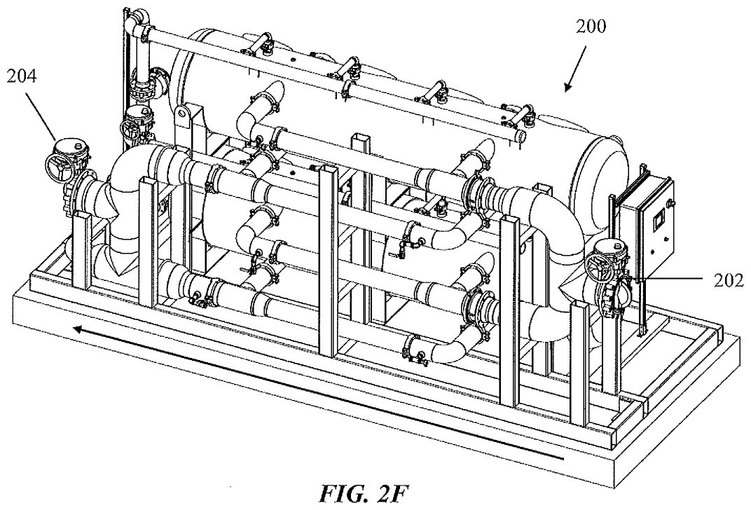

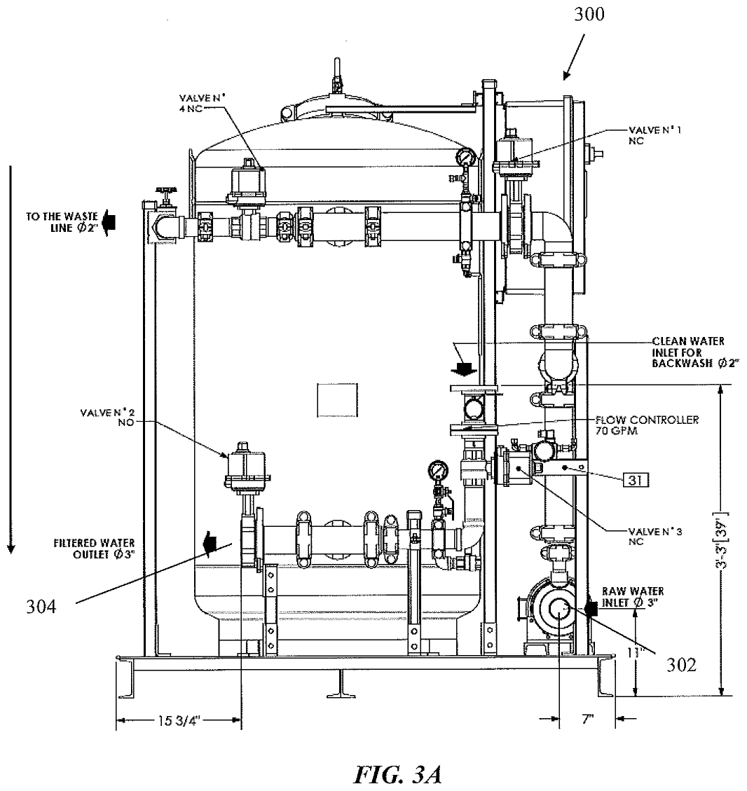

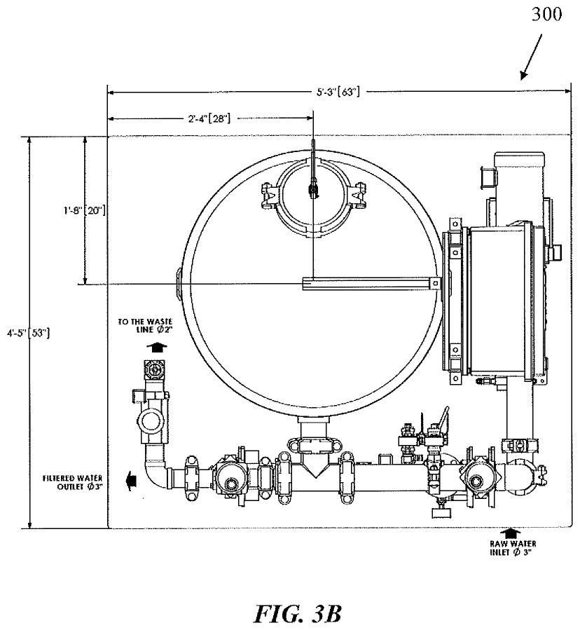

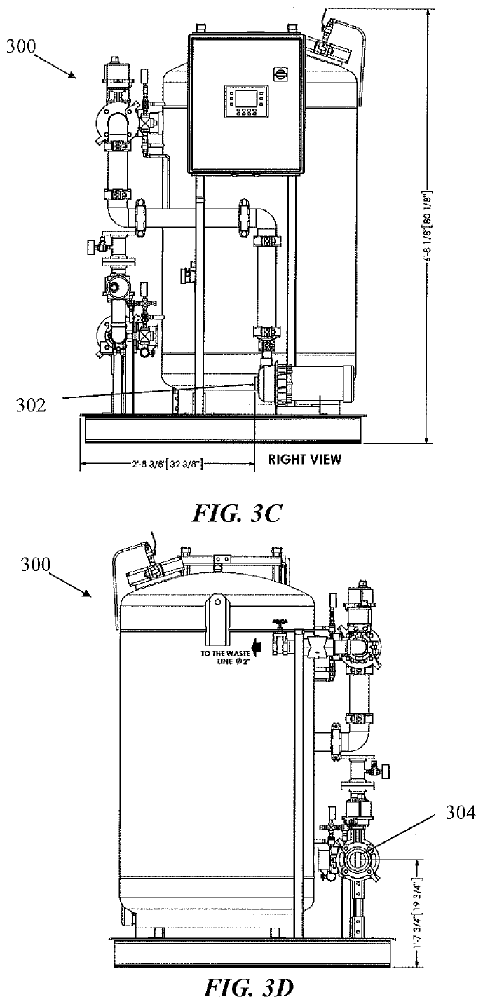

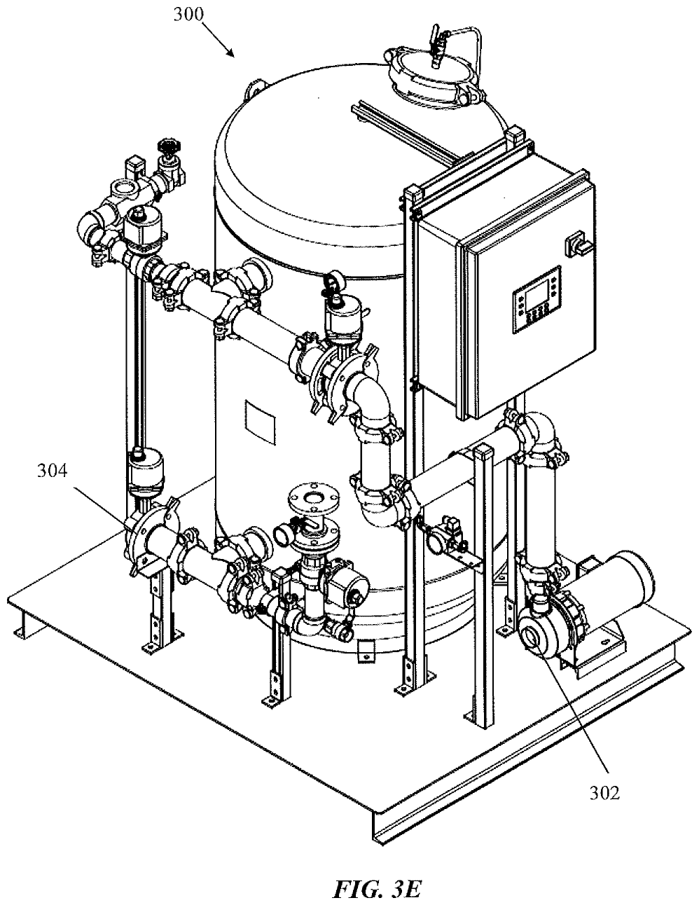

Filters useful for the present invention include both horizontal filters and vertical filters. Examples of horizontal and vertical filters are shown in FIGS. 2A-2F and 3A-3E, with the direction of fluid flow through both filter vessels shown with arrows. In both of the horizontal (FIGS. 2A-2F) and vertical (FIGS. 3A-3E) filter configurations, raw water enter filter 200, 300 at raw water inlet 202, 302, passes through the media (not shown) within the filter vessel 200, 300, and treated water is discharged from treated water outlet 204, 304. Filters useful for the present invention include an opening within the filter vessel 200, 300, such as a porthole, hatch, or other similar structure, that permits maintenance of the filter and the exchange of filter media as needed. Filters having these features are known in the art, for example, in WO 2014/012167 and U.S. Pat. No. 9,387,418, the disclosure of which is incorporated herein by reference in its entirety for all purposes. Exemplary filters include, but are not limited to, the series of VORTISAND® crossflow microsand submicron filters (Evoqua Water Technologies LLC, Pittsburgh, Pa.).

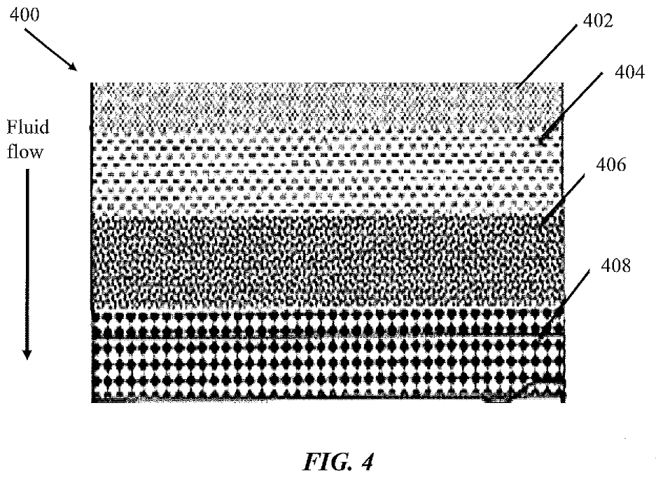

In accordance with certain embodiments, the plurality of media layers of the media bed increases in density from an uppermost media layer to a lowermost media layer. A schematic of a vertical filter vessel with a media bed having a plurality of media layers is shown in FIG. 4. As shown in FIG. 4, filter vessel 400 contains a plurality of layers and the direction of water flow through the layers of the media bed shown with an arrow. The finest media 402, for example glass micromedia, typically occupies the uppermost layer, with one or more intermediary stages 404, 406 of increasing coarseness, such as high-density ceramic particles or polymer beads, as one descends through the various layers vertically disposed within the filter vessel. Accordingly, the coarsest media 408, such as garnet particles, typically occupies the lowermost layer, and may or may not be supported by a screen. In some cases, the coarsest media 408 rests on the bottom of the filter vessel and a screen is associated with an outlet of the filter vessel. In particular, an uppermost media layer of the media bed may include a substantially uniform and spherical glass micromedia, for example glass beads, that have similar physical properties, such as density or diameter, to conventional filter media, such as silica microsand. Multi-layer media beds with an uppermost layer including a micromedia are described in US 2018/0099237, the disclosure of which is incorporated herein by reference in its entirety for all purposes.

Individual layers of the various media of the media bed, such as substantially uniform and spherical glass micromedia, for example glass beads, are neither typically disposed within nor delineated by finely defined by specific boundaries. Distribution of media having various grain sizes within a filter vessel is thus approximate and typically follows a gradual transition from top to bottom of each layer. In addition to shifting effects due to filtration and potentially other operations, it will be appreciated that achieving perfect stratification of media layers by particle size is typically even more elusive in some implementations because of ranges, variations and tolerances in particle size, density, and coarseness of media within each otherwise potentially distinguishable layer. Thus, a non-absolute boundary often in the form of an intermediate taper region may separate the various stratifications of media. Yet despite the non-ideal disposition of particle sizes, even an imperfect stratification is instrumental in ensuring that micromedia is not inadvertently lost, whether in the course of filtration operations or at any other time.

In use, deposits of contaminants, particularly those sized in excess of the coarseness of the finest media, are captured on or above the surface of the uppermost layer of the media bed, with further travel of said contaminants through the media bed being thereby impeded. In this scenario, a cake or crust may form at the uppermost surface of the media bed. Other contaminants, either similarly or comparably sized to the granularity of the uppermost media layer, may penetrate or have the top of the uppermost layer prior to an advanced consolidation of the cake or crust and be trapped or captured as particulates within a certain distance of travel through said uppermost layer. It will be appreciated that contaminants not trapped within the uppermost layer are unlikely to be trapped in any subsequent layer comprising successively coarser media.

In some embodiments, the filter vessel includes an air distributor positioned within the vessel configured to direct a volume of air through the plurality of media layers of the media bed. The air distributor typically includes at least one inlet that is connectable to a source of air, such as a compressed air tank or similar, and provides a substantially even flow of air throughout the plurality of media layers during a cleaning cycle, such as a backwash. The velocity of the air pumped through the air distributor required to fluidize the particles of the plurality of media layers depends on the physical properties of each type of particle in the plurality of media layers of the media bed. Suitable air distributors for filter vessels are known in the art.

The filter vessel may generally be connectable, and in use fluidically connected, to a source of water. In some embodiments, source of water to be treated may include water for human or veterinary applications, such as potable water or irrigation. Typically, the filter vessel may be positioned in the vicinity of the source of the water to be treated. In some embodiments, the media filter vessel may be remote from the source of the water to be treated.

The filter vessel may be of a size suitable for processing between 70 and 2500 gallons per minute (GPM) of water. For example, the media filter vessel may be sized to process about 70 GPM, about 100 GPM, about 250 GPM, about 500 GPM, about 1000 GPM, about 1500 GPM, about 2000 GPM or about 2500 GPM. The filter may comprise more than one vessel, arranged in series or in parallel. Generally, the size, number, and arrangement of filter vessels may vary with the scale of the source of water to be treated.

Micromedia particles, such as substantially uniform and spherical glass micromedia, for example glass beads, may be used as an uppermost layer of the multi-layer media bed to advantageously implement a still finer filter layer, rendering possible the capture of particulates whose size is concomitantly smaller. In the context of the present invention, micromedia generally refers to filtering media having a diameter less than 0.40 mm, and down to about 0.20 mm and preferably down to about 0.10 mm made from a material including, but not limited to, silica sand, glass, polymers, quartz, gravel, metal, or ceramic. Using micromedia, classes of previously unfilterable contaminants, such as living organisms, may thus be captured, in some cases rendering previously unpotable water potable. The term “glass micromedia” may be appreciated as encompassing any filtering glass or granular media having both size and filtering properties superior to the finest particle media known and used in the art. In particular, the Applicant has discovered that substantially uniform and spherical glass micromedia, for example glass beads, are exemplary glass micromedia for filters and systems of the present invention. Substantially uniform and spherical glass beads have traditionally been used in material removal applications, such as sand blasting, and are readily available from numerous suppliers, such as Manus Abrasive Systems Inc. (Mississauga, ON, Canada).

When substantially uniform and spherical glass beads are used at the micromedia for the uppermost layer of the filter, the glass beads may have a diameter from about 0.1 mm to 0.4 mm, such as a diameter from about 0.1 mm to 0.2 mm, about 0.15 mm to 0.25 mm, about 0.2 mm to 0.3 mm, about 0.25 mm to 0.35 mm, or about 0.3 mm to 0.4 mm. Alternatively, or in addition, substantially uniform and spherical glass beads may have diameters classified by whole integer sizes according to a published standard, such as a MIL-SPEC bead blasting performance standard (MIL-PRF-9954D). For example, #6 substantially uniform and spherical glass beads have a diameter of about 0.25 mm, while #8 substantially uniform and spherical glass beads have a diameter of about 0.15 mm.

In filters of the present invention, the size of the substantially uniform and spherical glass beads is substantially the same or smaller than the typical micromedia used for crossflow submicron filtration, silica microsand, and can be exchanged for said silica microsand without reconfiguration of the filter vessel or other components. When smaller substantially uniform and spherical glass beads are used as the uppermost layer in a media bed, the smaller spaces between individual glass beads allows for better filtration of smaller particulates, resulting in a cleaner treated water discharged from the filter.

The substantially uniform and spherical glass micromedia may have a uniformity coefficient of less than 1.25. As used herein, the “uniformity coefficient” is the ratio of the sieve size opening from which 60% of the media particles, by weight, will pass divided by the sieve size opening from which 10% of the media particles, by weight, will pass. In some embodiments, the substantially uniform and spherical glass beads may have a uniformity coefficient of less than 1.25, less than 1.0, less than 0.75, less than 0.5, or less than 0.25.

Substantially uniform and spherical glass micromedia, for example glass beads, are advantageous for use as a layer, such as the uppermost layer, in a multi-layer media bed due to their physical properties. Applicant has discovered that the use of substantially uniform and spherical glass micromedia as the uppermost layer of a multi-layer media bed offers improved filter performance, such as cleaner treated water and improved backwashing for cleaning the media when compared to conventional filters having silica microsand as the uppermost layer in a multi-layer media bed.

First, the substantially uniform and spherical glass beads useful in the present invention have nearly the same density for backwash purposes as silica microsand used in currently available filters. The substantially uniform and spherical glass beads useful for the filter vessels of the present invention have a density of about 2.5 g/mL compared to silica microsand that has a density of 2.7 g/mL. The comparable density of both micromedia results in interchangeability of the media without reconfiguration of the filter vessel or other components. For example, due to the similar density between the substantially uniform and spherical glass beads and silica microsand, the resulting expansion of the media during backwashing is similar for both media, highlighting the interchangeability of the media in the media beds of filter vessels.

Second, the substantially uniform and spherical glass beads have greater media bed expansion during backwash at typical backwash water velocities. During backwash, the media within the media bed will be displaced from their resting bed position by the backwash fluid, such as air or water. This mechanical action with the fluid passing over the media particles removes trapped contaminants, with the efficiency and effectiveness of backwash being dependent on the sphericity, roundness, and the surface finish of the substantially uniform and spherical glass beads and the temperature-dependent viscosity of the water being used to backwash the filter. For substantially uniform and spherical glass beads in media beds of the present invention, one inch of media bed expansion is typically not enough to dislodge contaminants trapped within the substantially uniform and spherical glass beads during backwash. Improved backwash can be achieved with expansion of the substantially uniform and spherical glass beads from about 2 inches to 6 inches of media expansion, such as 3 inches, such as 4 inches, such as 5 inches or such as 6 inches. If the expansion of the substantially uniform and spherical glass beads is too high, such as greater than about 6 inches, a portion of the substantially uniform and spherical glass beads will be lost when the soiled backwash water is flushed from the filter vessel. In addition, the substantially uniform and spherical glass beads have reduced wall effects, such as wall friction, with the walls of the filter vessel during the backwash process. The sphericity and outer surface of the substantially uniform and spherical glass beads reduce friction between the beads and the walls of the vessel when the media bed is fluidized during backwash relative to irregularly shaped silica microsand particles, thereby increasing the efficiency of backwash during media bed expansion.

Third, the hardness of the substantially uniform and spherical glass beads reduces losses due to attrition during the cleaning process. For example, glass media currently used in filtration systems is typically recycled or crushed glass, which is fragile. During backwash cleaning processes, the crushed glass media can break, decreasing its size and increasing the probability of the smaller pieces being lost when the backwash liquid is flushed from the system. Glass beads, such as those useful for the present invention, have a hardness substantially equivalent to silica microsand, and thus when the substantially uniform and spherical glass beads contact each other during backwash, they are less likely to fracture.

Last, substantially uniform and spherical glass beads useful for the present invention have a smooth and glossy outer surface finish. This surface finish reduces contaminants in the water adsorbing to the surface of the glass beads, thus reducing media fouling and extending the lifespan of the filter media. For example, when filtering with silica microsand, contaminants such as iron oxides, fats, and greases, tend to remain on the surface of the microsand particles, eventually fouling the microsand. In contrast, during media expansion that occurs when the media bed of a filter is backwashed, the outer surface finish of the substantially uniform and spherical glass beads is better able to shed contaminants trapped between the individual glass beads than conventional silica microsand. This results in a more efficient and more thorough backwash, decreasing filter downtime and less frequent replacement of the media.

In accordance with another aspect, a system for treating water is provided. The system includes a source of water to be treated, a filter vessel having at least one inlet fluidically connected to the source of water to be treated, at least one outlet, and a media bed positioned within the filter vessel, and a treated water outlet fluidically connected to a filter vessel outlet. In some embodiments, the media bed comprises a plurality of media layers, an uppermost layer of the media bed comprising substantially uniform and spherical glass bead micromedia, with the plurality of media layers increasing in density from the uppermost media layer to a lowermost media layer.

The filter of the system is suitable for the removal of organic or inorganic contaminants from the source of water to be treated. Organic contaminants in the source of water to be treated include, but are not limited to, fats, oils, greases, and biological species, such as algae. Inorganic contaminants in source of water to be treated include, but are not limited to, silt, clay, sand, and particulate heavy metals, such as iron. Other organic and inorganic contaminants that may be removed using filters of the invention in a system of the invention are known in the art.

In some embodiments, the system includes an air backwash system to facilitate cleaning of the media using an air backwash. The air backwash system typically includes an air distributor positioned within the vessel that includes at least one inlet that is connectable to a source of air, such as a compressed air tank or similar. The velocity of the air pumped through the air distributor required to fluidize the particles of the plurality of media layers depends on the physical properties of each type of particle in the plurality of media layers of the media bed. Suitable air distributors for filter vessels are known in the art.

Periodically, the media layers of the filter will require cleaning. As contaminants such as dirt and debris build up within the media layers of the filter, the pressure difference across an inlet and outlet of the filter vessel typically increases. Thus, filters are generally cleaned once the differential pressure reaches a predetermined threshold level as indicated by a decrease in the performance of the filter vessel. In some embodiments, the system may include a pressure sensor configured to measure the differential pressure of water across the filter vessel. For example, the pressure sensor may be configured to measure differential pressure between a liquid inlet and a liquid outlet of the media filter vessel. Accordingly, the pressure sensor may be a differential pressure sensor. The pressure sensor may be electronic. The pressure sensor may be digital or analog. In some embodiments, the media filter vessel may be cleaned once the differential pressure reaches 5 psi. For example, the media filter vessel may be cleaned once the differential pressure is at least 7 psi, 10 psi, 12 psi, or 15 psi. In some cases, the performance of the filter may be monitored by measuring a property of the discharged water, such as by measuring the turbidity of the treated water that is discharged from the treated water outlet using filtration or an optical technique.

Cleaning of the filters in the system of the invention, as noted above, is typically performed using a backwash. Backwashing generally involves reversing flow of the water or other medium, such as air, through the media layers of the filter bed and discharging the soiled water out of an outlet, such as a backwash outlet, of the filter vessel. The backwashing process may be performed continuously or intermittently (for example, in cycles) until the discharged water is substantially clear, the differential pressure has reached a predetermined level, or for a predetermined period of time based on the size of the filter and flow rate of the water during a filtration cycle. Backwashing may be performed once daily, multiple times a day, or as needed. Backwashing may be performed for a period of time as needed to discharge contaminants from the vessel or to reduce the differential pressure to a working range.

In some embodiments, air is used to backwash the plurality of media layers of the filter's media bed. Air backwashing can be more effective at cleaning than liquid backwashing. In this case, a liquid level above the media bed can be lowered, and air can be introduced below the media to force liquid and air through the media bed, thus causing media to be mixed and propelled into the liquid above the media bed. Air then escapes from the top of the filter reservoir, while the liquid above the media bed is filled with a mix of contaminants and media. The media in suspension is then re-stratified to return to the normal media bed. This can be achieved by controlled liquid flow up through the suspended media to cause deposition of the media sorted by particle size. The contaminants in the liquid above the media bed can be flushed away. Liquid- and air-based backwashing for filters incorporating a multi-layer media bed having a micromedia as the uppermost layer is described in US 2018/0099237, the disclosure of which is incorporated herein by reference in its entirety for all purposes.

In the present invention, where a substantially uniform and spherical glass micromedia comprises the uppermost layer of the media bed of the filter vessel, control of the flow rates used during backwash is important to reduce de-stratification of the layers of the media bed and to reduce losses of the substantially uniform and spherical glass micromedia when the backwash water is discharged. The liquid flow rates used in regular filter bed media stratification are too high for substantially uniform and spherical glass micromedia. Applicants have found that the layers of the media can remain stratified during an air backwash, as long as the density of the media increases with particle size so as to help with stratification and the air flow is controlled so as not to create mixing. During this air backwash, the lower layers of the media are not disturbed, and the micromedia can remain in a liquid suspension above lower layers. A low-level liquid backwash flow can be combined, as long as the liquid flow does not cause substantially uniform and spherical glass micromedia to be flushed out of the filter vessel. The higher density also helps keep the substantially uniform and spherical glass micromedia separated from the larger particle size media during stratification, and thus prevents the substantially uniform and spherical glass micromedia from being trapped into the rest of the media. When the air and liquid backwash is stopped, the substantially uniform and spherical glass micromedia is on top of the remaining stratified media.

The volumes of air used to backwash the media layers produces bubbles that move within the plurality of layers of the media bed; these bubbles result in the substantially uniform and spherical glass micromedia mixing with the water layer (whose level reaches a comparatively significant height above the top of the media bed). The substantially uniform and spherical glass micromedia remains separated from other media in the media bed. As the bubbles push upward into the water layer within the filter vessel, a counter current of water flows downward without creating a powerful through-flow as seen in conventional air backwashing. This action thus operates an overall flow exchange where contaminants gradually flow upward from the media bed and are accordingly collected into the water layer between the liquid level and the top of the media bed. The bubbling action causes contaminants either adhering to or caught between the substantially uniform and spherical glass micromedia particles to be lifted into the water layer. As a result of this flow exchange, contaminants collected in the water layer are not trapped back into the substantially uniform and spherical glass micromedia layer of the media bed when the air is stopped. Instead, once the contents of the media bed are determined to be clean, a slow flush of the soiled contents mixed within the water layer is done. While this flow rate is in practice not imperceptible, it is important to ensure that the flow rate at which this flushing occurs be gentle enough as to not upset the uppermost substantially uniform and spherical glass micromedia layer of the media bed and in so doing upset the overall stratification required by the filter. Alternatively, the contaminants collected in the water layer following re-stratification can be done from the top of the media only, namely by injecting clean water through an inlet, and flushing contaminated water out through an outlet.

It will be appreciated that the use of lower density micromedia for the uppermost layer of the media bed, with increasing densities for successive layers, prevents de-stratification of said layers when the air backwash operation ends. The air bubbles and the current that they produce do not work to upset or otherwise de-stratify the layers of the media bed. Thus, the air backwash cleaning process causes little movement in the lower supporting media layer that is coarsest but can disturb and cause homogenization of the substantially uniform and spherical glass micromedia and the coarser media that support the substantially uniform and spherical glass micromedia. To avoid any significant disturbance of the substantially uniform and spherical glass micromedia, following the air backwash, the substantially uniform and spherical glass micromedia separates from and settles on top of the next coarser media. This is achieved primarily by selecting a higher density for the coarser supporting media than for the substantially uniform and spherical glass micromedia. The addition of a low-level reverse flow of liquid at the end of the air backwash can also help in separating the micromedia from the coarser supporting media during the settling process. This reverse flow need not put at risk any loss of the substantially uniform and spherical glass micromedia through the top of the filter vessel. The air flow in the backwash can be reduced so that the coarser media can settle while leaving the substantially uniform and spherical glass micromedia to be suspended above. Then, when the air flow is arrested, no mixing between the substantially uniform and spherical glass micromedia and the next coarsest media takes place. Thus, re-stratification is avoided without loss of the substantially uniform and spherical glass micromedia.

Volumes of air used to backwash the media layers of the media bed may be delivered to the media bed by an air distributor of an air backwash system positioned within the vessel, typically underneath the media layers. The volumes of air necessary to backwash the media bed may be delivered at a predetermined period of time during a filtration cycle. Alternatively or in addition, the volumes of air necessary to backwash the media bed may be delivered based on the monitored value or values of a filter vessel performance metric, such as a differential pressure change of water across the filter vessel as measured by a pressure sensor or a measurement of a property of the discharged water, such as the turbidity as measured by filtration or an optical technique.

In some embodiments, the system may further comprise a controller operably connected to the pressure sensor. The controller may be a computer or mobile device. The controller may comprise a touch pad or other operating interface. For example, the controller may be operated through a keyboard and/or mouse. The controller may be configured to run software on an operating system known to one of ordinary skill in the art. The controller may be electrically connected to a power source. The controller may be digitally connected to the pressure sensor.

The controller may be connected to the pressure sensor through a wireless connection. The controller may further be operably connected to any pump or valve within the system, for example, to enable the controller to initiate or terminate the cleaning process as needed.

The controller may be configured to initiate a cleaning process of the filter vessel responsive to the differential pressure measured by the pressure sensor. In some embodiments, the controller may be configured to initiate the cleaning process at a threshold differential pressure. The threshold differential pressure may be associated with deteriorated operation of the media filter vessel. For example, the threshold differential pressure may be 5 psi, 7 psi, 10 psi, 12 psi, or 15 psi. The controller may further be configured to initiate clean operation of the filter vessel upon completion of the cleaning process. The controller may be configured to initiate operation at a second threshold differential pressure. The second threshold differential pressure may be associated with clean operation of the media filter vessel. For example, the second threshold differential pressure may be 12 psi, 10 psi, 7 psi, 5 psi, 3 psi, 1 psi, or less than 1 psi. Alternatively, or in addition, a controller may be configured to initiate a cleaning process of the filter vessel responsive to an increase in the turbidity of the discharged water from the treated water outlet, as measured by a filtration technique, such as the Silt Density Index (SDI) test, or an optical technique. Other metrics useful for measuring filter performance and initiating a cleaning using backwash are known in the art.

In accordance with another aspect, there is provided a method of retrofitting a media filter comprising a filter vessel fluidly as described herein. The method may comprise removing the uppermost media layer from the media bed and installing a media comprising substantially uniform and spherical glass bead micromedia into the media bed as the uppermost media layer. The glass bead micromedia may be the glass beads as described herein, for example, glass beads having a diameter from about 0.1 mm to 0.4 mm, a density of about 2.5 g/mL, and a smooth and glossy outer surface.

In accordance with another aspect, there is provided a method of facilitating water treatment with a filter vessel. The method may comprise providing a filter vessel comprising at least one inlet, at least one outlet, an air distributor, and a media bed as described herein. The method may further comprise instructing a user to connect an inlet of the filter vessel to a source of water to be treated.

In some embodiments, the method of facilitating water treatment may further include instructing the user to connect a source of air, such as a compressed air tank, to an inlet of the air distributor. The method of facilitating water treatment may further include instructing the user to direct a volume of air through the air distributor and the plurality of media layers for a predetermined period of time.

### EXAMPLES

The function and advantages of these and other embodiments can be better understood from the following examples. These examples are intended to be illustrative in nature and are not considered to be limiting the scope of the invention.

### Example 1: Reducing Media Fouling in an Iron Removal Application

The following example was used to investigate media fouling in an iron removal process. It was observed that micromedia comprising silica sand (D10≈0.15 mm-D50≈0.23 mm) fouls rapidly when in an iron removal application. As a potential solution to this problem, glass beads (#8, D50≈0.18 mm), typically used for sand blasting, were used in the filter by exchanging the silica sand for the glass beads.

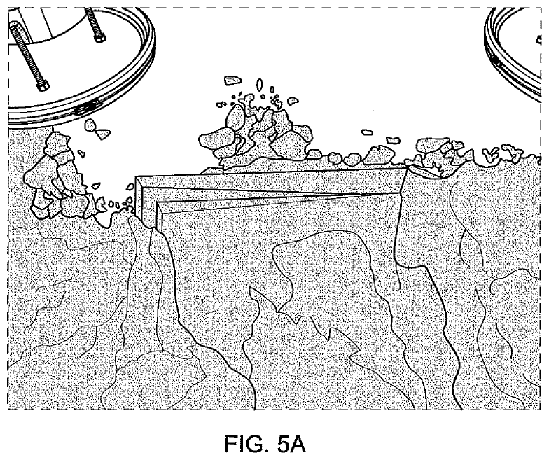

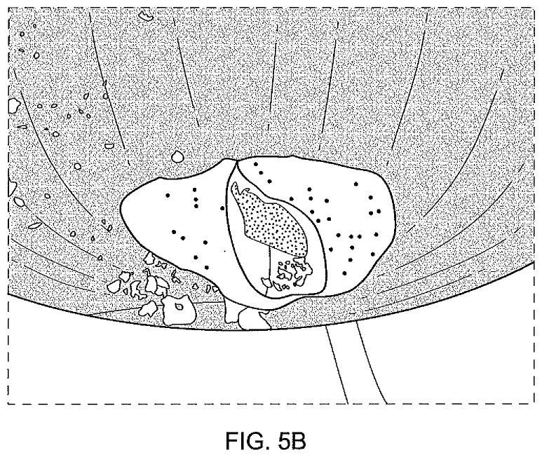

The glass beads have surface characteristics that facilitate improved cleaning of the media during a backwash cycle of a filter, such as the VORTISAND® Crossflow Microsand Filter (Evoqua Water Technologies LLC, Pittsburgh, Pa.). In particular, the smooth and glossy outer surface of the glass beads allows a better removal of the filtered iron compared to the silica sand micromedia used in the standard VORTISAND® filter units. The smooth and glossy outer surface of the glass beads extends their lifespan and maintains filtration performance, as the smooth and glossy surface of the glass beads reduces fouling compared to silica sand micromedia. As is shown in FIGS. 5A-5B, under the same operating conditions including backwashing cycles as described herein, microsand media (FIG. 5A) begins to foul with iron that is not effectively removed during backwash cycles. In contrast, glass bead micromedia (shown in FIG. 5B as a zoomed in image of a single glass bead) shows reduced iron content on the glass bead outer surface, indicating more thorough removal of iron throughout the uppermost media layer during backwash.

### Example 2: Turbidity Reduction in Water Prior to Reverse Osmosis (RO)

The following example was used to investigate the reduction of turbidity in water using glass beads (#8, ≈0.15 mm) as the top layer in a filtration system. It is a goal of this example to reduce the turbidity of water as measured by the SDI test to minimize RO membrane fouling that would necessitate chemical cleaning of the RO and a reduction in the filtration cycle range. This has the benefit of increasing the lifespan of the RO membranes as they need to be chemically cleaned less frequently.

The glass beads have surface characteristics that facilitate improved cleaning of the media during a backwash cycle of a filter, such as the VORTISAND® Crossflow Microsand Filter (Evoqua Water Technologies LLC, Pittsburgh, Pa.). In particular, the smooth and glossy outer surface of the glass beads allows for a reduction in turbidity compared to the silica sand micromedia used in the standard VORTISAND® filter units. The smooth and glossy outer surface of the glass beads extends their lifespan and maintains filtration performance, as the smooth and glossy surface of the glass beads reduces fouling compared to silica sand micromedia. Moreover, the glass beads are smaller than the silica sand micromedia (0.15 mm) and can remove more of the remaining particles from the water, and in particular, remove the smallest particles that generate turbidity in the water.

Tables 1 and 2 present comparative data for the reduction in turbidity (as measured in Nephelometric Turbidity Units (NTUs)) (Table 1) and Silt Density Indices (SDI) (Table 2) for process water originating from a treated municipal water source. The SDI was calculated according to the ASTM D4189-07 protocol using an Automatic Simple SDI testing apparatus. In Tables 1 and 2, outlets A and B refer to filter vessel outlets from filters with the uppermost media layer being 0.18 mm glass bead micromedia and outlets C and D refer to filter vessel outlets from filters with the uppermost media layer being 0.25 mm silica microsand media. The data presented in Tables 1 and 2 was collected with a single inlet manifold feeding the inlets of four individual filter vessels via a distribution manifold, each vessel being 36″ in diameter with a filtration capacity of 215-280 gpm. The data shown for the inlet was collected at a sampling point upstream of the distribution manifold. Each of the four filter vessels has an outlet where treated water may be drawn for testing; the individual outlets also feed a downstream outlet manifold having a single outlet.

TABLE 1
Turbidity Measurements for Process Water Originating
from Treated Municipal Water Source Using
Microsand and Glass Bead Micromedia

| | Date | | |
|---|---|---|---|
| | Sep. 17, 2018 | Sep. 19, 2018 | Sep. 19, 2018 |
| Time (24 hour) | 15:50 | 14:50 | 15:30 |
| Pressure drop (psi) | — | 11.5 | 7.0 |
| Uppermost Media | Microsand | Glass Beads | Microsand |
| | (Vessels A-D) | (Vessel B) | (Vessels C + D) |
| Inlet Turbidity | 0.34 | 0.07 | 0.07 |
| (NTU) | | | |
| Outlet A Turbidity | 0.11 (measured | — | — |
| (NTU) | at outlet | | |
| Outlet B Turbidity | manifold) | 0.02 | — |
| (NTU) | | | |
| Outlet C Turbidity | | — | 0.06 |
| (NTU) | | | |
| Outlet D Turbidity | | — | 0.07 |
| (NTU) | | | |
| Removal (%) | 69% | 71% | 0% |

The data in Table 1 from on Sep. 17, 2018 was collected from the collective output of the four filter vessels A-D prior to the replacement of the silica microsand uppermost media layer with glass bead micromedia in vessel A and B. Using the original silica microsand media layer, the total filtration system of vessels A-D had a 69% reduction in turbidity from the feed water as measured at the outlet manifold. On Sep. 19, 2018, the uppermost media layer in vessel B was exchanged out for glass bead micromedia. Filtration through the vessel B with the glass bead micromedia resulted in a71% reduction in turbidity compared to the turbidity of vessels C+D containing silica microsand, which did not decrease the turbidity of the feed water. For the experiment of Sep. 19, 2018, the turbidity of the feed water was low and due to very small suspended particulates. The more effective packing of and smaller interstitial spaces formed between the glass bead micromedia allow for the more effective capture of smaller particulates and a concomitant reduction in turbidity, whereas the silica microsand cannot capture the smallest particulates.

TABLE 2
SDI Measurements for Process Water Originating from Treated Municipal
Water Source Using Microsand and Glass Bead Micromedia

| | Inlet | Outlet A | | | | | Outlet B | Inlet | Outlet C | | Outlet D |
|---|---|---|---|---|---|---|---|---|---|---|---|
| | Media† | | | | | | | | | | |
| | — | GB | GB | GB | GB | GB | GB | — | Sand | Sand | Sand |
| Time (24 hr) | 10:20 | 10:29 | 10:56 | 11:20 | 11:35 | 12:56 | 13:40 | 14:30 | 15:50 | 16:14 | 17:00 |
| Filtration | 0.3 | 0.5 | 1.0 | 1.3 | 1.5 | 2 | 2.6 | 0.5 | 1.8 | 2.3 | 3 |
| Hours | | | | | | | | | | | |
| Pressure | 10 | 10 | 10 | 10 | 11.5 | 11.5 | 11.5 | 7 | 7 | 7 | 7 |
| drop (psi) | | | | | | | | | | | |
| SDI-5(100) | 18.8 | 17.5 | 16.8 | 16.5 | 9.3 | 15.4 | 15.2 | 16.5 | 15.5 | 15.7 | 15.7 |
| SDI-5(500) | O.R. | O.R. | 16.9 | 16.4 | 8.9 | 14.9 | 14.5 | 16.3 | 14.5 | 14.8 | 14.9 |
| SDI-10(100) | — | — | 9.4 | 9.3 | 6.3 | 8.7 | 8.6 | 9.2 | 8.6 | 8.7 | 8.8 |
| SDI-10(100)^{‡} | — | — | O.R | O.R. | 6.4 | 8.6 | 8.4 | O.R. | 8.4 | 8.5 | 8.7 |
| SDI-15(100) | — | — | — | — | 5.1 | 6.2 | 6.0 | — | 6.1 | 6.1 | 6.2 |
| SDI-15(100) | — | — | — | — | O.R. | O.R. | O.R. | — | O.R. | O.R. | O.R, |
| SDI Removal | — | 1.3 | 9.4 | 9.5 | 13.7 | 12.6 | 12.8 | — | 10.4 | 10.4 | 10.3 |
| SDI Removal | — | 7 | 50 | 51 | 73 | 72 | 76 | — | 63 | 63 | 62 |
| (%) | | | | | | | | | | | |

†GB designates 0.18 mm glass bead micromedia
^{‡}SDI-X(YYY) - X is time in minutes; Y is filtered volume in mL [symbol]
O.R. designates an over range measurement

The ASTM D14189-07 data collection method allows for the collection of SDI data at 5-minute intervals, such as at 5 minutes, 10 minutes, and 15 minutes, using a standard 500 mL volume of water. The ASTM D4189-07 data collection method is pressure sensitive and allows for the use of a smaller volume of water if the pressure exceed a certain threshold due to clogging of the filter, such as a volume of 100 mL.

As is seen in the data of Table 2, the overall filtration performance for glass bead micromedia increases with the amount of time the water is filtered. For example, for the glass bead micromedia in vessel A, the SDI decreased 7% from the feed water after 30 minutes of filtration, decreased 50% after 1 hour of filtration, and decreased 73% after two hours of filtration. In contrast, the performance of microsand media filters (vessels C and D) was steady across filtration time, with the greatest change within the first 30-60 minutes of filtration and no appreciable increase in performance as filtration proceeded. The glass bead micromedia demonstrated improved SDI removal performance compared to the silica microsand media.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, that are to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A filter comprising:
a vessel having at least one inlet and at least one outlet;
a media bed comprising a plurality of media layers, an uppermost media layer of the media bed comprising substantially uniform and spherical glass micromedia, the plurality of media layers increasing in density from the uppermost media layer to a lowermost media layer; and
an air distributor configured to direct a volume of air through the plurality of media layers.

2. The filter of claim 1, wherein the glass micromedia comprises glass beads.

3. The filter of claim 2, wherein the glass beads have a diameter from about 0.1 mm to 0.4 mm.

4. The filter of claim 3, wherein the glass beads have a diameter from about 0.1 mm to 0.2 mm.

5. The filter of claim 2, wherein the glass beads comprise a smooth exterior surface.

6. The filter of claim 2, wherein the glass beads have a density of about 2.5 g/mL.

7. A method of retrofitting a media filter comprising a filter vessel fluidly connectable to a source of water, the filter vessel comprising a media bed comprising a plurality of media layers, the plurality of media layers increasing in density from an uppermost media layer to a lowermost media layer, the method comprising:
removing the uppermost media layer from the media bed; and
installing a media comprising substantially uniform and spherical glass bead micromedia into the media bed as the uppermost media layer.

8. The method of claim 7, wherein the glass beads have a diameter from about 0.1 mm to 0.4 mm.

9. The method of claim 8, wherein the glass beads have a diameter from about 0.1 mm to 0.2 mm.

10. The method of claim 7, wherein the glass beads have a density of about 2.5 g/mL.

11. A method of facilitating water treatment, the method comprising:
providing a filter vessel comprising at least one inlet, at least one outlet, an air distributor, and a media bed, the media bed comprising a plurality of media layers, the plurality of media layers increasing in density from an uppermost media layer to a lowermost media layer, wherein the uppermost media layer comprises substantially uniform and spherical glass bead micromedia; and
instructing a user to connect an inlet of the filter vessel to a source of water to be treated.

12. The method of claim 11, further comprising instructing the user to connect a source of air to the air distributor.

13. The method of claim 12, further comprising instructing the user to direct a volume of air through the air distributor and the plurality of media layers for a predetermined period of time.

14. A system for treating water, comprising:
a source of water to be treated;
a filter vessel having at least one inlet fluidically connected to the source of water to be treated, at least one outlet, and a media bed positioned within the filter vessel, the media bed comprising a plurality of media layers, an uppermost layer of the media bed comprising substantially uniform and spherical glass bead micromedia, the plurality of media layers increasing in density from the uppermost media layer to a lowermost media layer; and
a treated water outlet fluidically connected to a filter vessel outlet.

15. The system of claim 14, wherein the glass beads have a diameter from about 0.1 mm to 0.4 mm.

16. The system of claim 15, wherein the glass beads have a diameter from about 0.1 mm to 0.2 mm.

17. The system of claim 14, wherein the glass beads have a density of about 2.5 g/mL.

18. The system of claim 14, wherein the source of water to be treated comprises inorganic or organic contaminants.

19. The system of claim 14, further comprising an air backwash system, comprising an air distributor positioned within the filter vessel having an inlet connectable to a source of air.

20. The system of claim 19, wherein a volume of air is delivered from the air distributor at a predetermined period of time during a filtration cycle and/or when the performance of the filter vessel decreases.
